(19) United States
(12) Patent Application Publication
(10) Pub. No.: US 2015/0260666 A1
(43) Pub. Date: Sep. 17, 2015

(54) METHOD FOR DETERMINING WETTABILITY

(71) Applicant: SCHLUMBERGER TECHNOLOGY CORPORATION, Sugar Land, TX (US)

(72) Inventor: Evgeny Nikolaevich Dyshlyuk, Dhahran (SA)

(21) Appl. No.: 14/642,697

(22) Filed: Mar. 9, 2015

(30) Foreign Application Priority Data
Mar. 11, 2014 (RU) 2014109083

(51) Int. Cl. G01N 25/20

(52) U.S. Cl. CPC G01N 25/20

(57) ABSTRACT

In order to determine surface wettability of a material, at least one sample of the material is placed into at least one sealed calorimeter cell. The at least one sample is brought into contact with a first wetting liquid and with a second wetting liquid at the same pressure and temperature. Heats of immersion of a surface of the at least one sample by the first and second wetting liquids are measured, then the wettability is calculated.

### CROSS-REFERENCE TO RELATED APPLICATION

This application claims priority to Russian Application No. 2014109083 filed Mar. 11, 2014, which is incorporated herein by reference in its entirety.

### TECHNICAL FIELD

The invention relates to studying wettability of surfaces and can be used in different industrial fields, for example, in petroleum, chemical, paint and food industries.

### BACKGROUND

Wettability is the ability of a liquid to spread on a surface of a solid body, remain in contact or lose contact with the surface in presence of another liquid immiscible with the former one. Wettability is one of the basic properties describing how two immiscible liquids interact with the surface of a solid body. It is important for petroleum, pharmaceutical, fabrics and other industries.

For example, in petroleum industry wettability is one of the basic properties that defines position of fluids in porous space of a reservoir, as well as fluid flow distribution. Being a basic parameter defining the position of fluids in reservoir pore space, rock wettability affects all measurements of reservoir properties, including electrical properties, capillary pressure, relative permeability, etc. Wettability also has large effects on selecting oil production techniques and production efficiency, especially on secondary and tertiary oil recovery methods.

The key method for evaluating wettability of a solid surface by two immiscible liquids is the method for determination of contact angle formed by fluid interface and solid surface (see, for example, U.S. Pat. No. 7,952,698).

The main disadvantages of this known method are long time required to achieve a balanced contact angle (up to 1000 hours), contact angle hysteresis caused by different factors, such as, for example, heterogeneous structure of the surface, surface irregularities, etc. Another serious disadvantage is that this method can be applied mostly to even flat surfaces. Adapting this method to measurements in porous media is rather difficult and, in some cases, is impossible. For example, determining wettability of a porous media in petroleum industry in most cases involves petrophysical studies of core samples rather than contact angle determination. Other methods of wettability determination can only be applied in very few cases, when wettability pattern is very distinct. The principal method used during petrophysical studies of core samples is the Amott test (E. Amott, “Observations Relating to the Wettability of Porous Media,” Trans, AIME, 216, 156-162,1959) or its modifications: the Amott-Harvey method and USBM (see, for example, J. C. Trantham, R. L. Clampitt, “Determination of Oil Saturation After Waterflooding in an Oil-Wet Reservoir—The North Burbank Unit, Tract 97 Project,” JPT, 491-500 (1977)).

All these methods, in one way or another, imitate the process of producing oil from a reservoir and are based on sequential displacement of oil by a mineral solution or a mineral solution by oil in the tested core sample by natural or forced (by centrifuge) saturation of the core sample and measurement of fluid saturation. All the above methods are indirect methods of measurements and cannot provide accurate thermodynamic data about such important thermodynamic characteristic as wettability. Another disadvantage of these methods is their low sensitivity in the neutral wettability area or in small core samples.

Recently, a method of determining wettability based on calorimetry measurements has become more widespread. Studies were conducted to investigate wettability in the system consisting of solid, liquid and gas (saturated vapor of the tested fluid) (see, for example, R. Denoyel, I. Beurroies, B. Lefevre, “Thermodynamics of wetting: information brought by microcalorimetry,” J. of Petr. Sci. and Eng., 45, 203-212, 2004).

Investigating wettability in the system consisting of solid surface-liquid-saturated vapor of the tested liquid does not allow us to evaluate wettability in a system with two different liquids, such as a solid surface-liquid-liquid. For instance, the information that water wets the given surface in the system with saturated water vapor does not tell us anything about wettability of the same surface by water in the system with other liquid, for example, with oil.

### SUMMARY

The disclosure provides higher quality and efficiency of determining surface wettability by two fluids at different pressures and temperatures, higher speed of measurements with lower risks of improperly conducting such measurements.

According to the proposed method for wettability determination, at least one sample of a material is placed into at least one sealed calorimeter cell. A contact is provided of the at least one sample with a first wetting liquid and then with a second wetting liquid at the same pressure and temperature. Heats of immersion of a surface of the at least one sample by the first and the second wetting liquids are measured. Wettability is calculated as

$$W = \frac{{Δ}_{imm} {u}_{1} \frac{{γ}^{{L}_{1}}}{{γ}^{{L}_{1}} - T \frac{\partial {γ}^{{L}_{1}}}{\partial T}} - {Δ}_{imm} {u}_{2} \frac{{γ}^{{L}_{2}}}{{γ}^{{L}_{2}} - T \frac{\partial {γ}^{{L}_{2}}}{\partial T}}}{A {γ}^{{L}_{1} {L}_{2}}}$$

where

Δᵢₘₘu₁ is the heat of immersion of the surface of the sample by the first wetting liquid, J,

Δᵢₘₘ₂ is the heat of immersion of the surface of the sample by the second wetting liquid, J,

A—is a surface area of the sample,

γ^{L}^{₁}—a surface tension of the first wetting liquid in equilibrium with its vapor, N/m,

γ^{L}^{₂}—a surface tension of the second wetting liquid in equilibrium with its vapor, N/m,

γ^{L}^{₁}^{L}^{₂}—an interfacial tension between the first and the second wetting liquids, N/m,

T—temperature at which measurements are carried out, K,

$$\frac{\partial }{\partial T} {γ}^{{L}_{1}}$$

—a change in the surface tension of the first wetting liquid with temperature,

N/(m·K),

$$\frac{\partial }{\partial T} {γ}^{{L}_{2}}$$

—a change in the surface tension of the second wetting liquid with temperature, N/(m·K).

Prior to measurements, the first and the second wetting liquids are brought into contact with each other at the pressure and temperature at which the heats of immersion are determined.

The sample surface area required for calculating the wettability could be found using gas adsorption method or using a calorimeter according to the Harkins-Jura method.

The interfacial tension between the wetting liquids, the surface tensions of the wetting liquids in equilibrium with their own vapors and the changes in the surface tensions of the liquids can be determined by the spinning drop method or the sessile drop method.

According to one embodiment, the sample is brought into contact with the first wetting liquid and the heat of immersion energy of the surface of the sample by the first wetting liquid is measured. Then the sample surface is cleaned, and the sample is placed into the same calorimeter cell and brought into contact with the second wetting liquid. The heat of immersion of the surface of the sample by the second wetting liquid is measured.

According to another embodiment, two identical samples with the same surface area are used. Each sample is placed into separate cells, one of the samples is brought into contact with the first wetting liquid, and the other sample is brought into contact with the second wetting liquid. Heat of immersion of the surface of the first sample by the first wetting liquid and heat of immersion of the surface of the second sample by the second wetting liquid are measured simultaneously.

Before measurements, samples can be dried, cleaned and vacuumed.

The cell with the sample can be held at the temperature at which the heat of immersion of the sample surface is measured until stabilization of the heat flow.

A core can be used as the sample.

Any immiscible liquids can be used as wetting liquids. Specifically, such liquids can be oil and water or brine, including those at reservoir pressure and temperature.

### DETAILED DESCRIPTION

A sample of a material is placed in a cell of a differential scanning calorimeter (DSC). DSC can operate at different temperatures (temperature range depends on calorimeter model). Some DSC's can be equipped with cells for high-pressure or vacuum measurements. In order to conduct disclosed measurements the DSC should be combined with a system capable of creating a controlled pressure in the cells of the calorimeter. Such system allows for controlling cell pressure to ensure high quality of wettability measurements, including measurements under high pressure. The pressure supply system may include pumps of various types, combined with pressure sensors attached to the calorimeter cells by connection tubes.

A macroscopic contact angle between the liquid 1-liquid 2 interphase boundary (designated as L₁ and L₂) and the solid surface (S), measured from the contact of one of the liquids (for example, L₂; normally, a denser liquid is chosen) with the surface, is a convenient wettability characteristic of the surface. The Young equation relates the magnitudes of excessive surface energies (surface tensions) at interphase boundaries with the value of contact angle:

$$cos Θ = \frac{{γ}^{{SL}_{1}} - {γ}^{{SL}_{2}}}{{γ}^{{L}_{1} {L}_{2}}} . \qquad ( 1 )$$

When γ_{SL}^{₁}−γ_{SL}^{₂}>γ_{L}^{₁}^{L}^{₂}, the contact angle is not formed, the liquid L₂ will spread on the surface without forming a contact angle and displacing the liquid L₁; likewise, when γ^{SL}^{₂}−γ_{SL}^{₁}<γ^{L}^{₁}^{L}^{₂}, the liquid L₁ will displace L₂ from the surface. Thus, for surface-liquid-liquid systems classification, it is convenient to introduce wettability parameter W, which can take values less than −1 and greater than 1:

$$W = \frac{{γ}^{{SL}_{1}} - {γ}^{{SL}_{2}}}{{γ}^{{L}_{1} {L}_{2}}} . \qquad ( 2 )$$

When the final contact angle W=cos θ is formed, with W>1, L₂ will displace L₁ from the surface, and with W<−1 L₁ will displace L₂ from the surface. Thus, parameter W contains all information we need about wettability.

Heat of immersion is the energy that is emitted (or absorbed) when a surface, which was in contact with some medium M (gas, vacuum), is immersed in a liquid L so that the entire surface S, which was in contact with such medium, is covered by a macroscopic layer of liquid. The heat of immersion depends on initial condition of the surface. Besides, presence of gas in the sample before the immersion may not allow the liquid to fully wet the entire surface of the sample. Thus, when heat of immersion is measured, the sample is immersed from vacuum. Typically, longer vacuuming is required at high temperatures. Time and temperature depend on the sample. Such measurements often require sample vacuuming during 24 hours at a temperature about 100° C. DSC units allow to measure heat of immersion at different temperature and pressure conditions. Heat of immersion obtained at a constant pressure in the system has the following relation with changes in surface tension at the solid surface boundary:

$${Δ}_{imm} u = A [ ( {γ}^{SL} - {γ}^{SM} ) - T \frac{\partial }{\partial T} ( {γ}^{SL} - {γ}^{SM} ) ] \qquad ( 3 )$$

where Δᵢₘₘu—the heat of immersion, A—is a surface area of the sample, γ_{SL}—a surface tension at the solid-liquid interface (after wetting), γ^{SM}—a surface tension at the solid-gas (vacuum) interface before immersion, T—temperature at which measurements are made. From (2 and 3) one can obtain:

$$W = \frac{\begin{matrix}{Δ}_{imm} {u}_{1} \frac{{γ}^{S} - {γ}^{{SL}_{1}}}{( {γ}^{S} - {γ}^{{SL}_{1}} ) - T \frac{\partial }{\partial T} ( {γ}^{S} - {γ}^{{SL}_{1}} )} - \\ {Δ}_{imm} {u}_{2} \frac{{γ}^{S} - {γ}^{{SL}_{2}}}{( {γ}^{S} - {γ}^{{SL}_{2}} ) - T \frac{\partial }{\partial T} ( {γ}^{S} - {γ}^{{SL}_{2}} )}\end{matrix}}{A {γ}^{{L}_{1} {L}_{2}}} \qquad ( 4 )$$

Experimentally it can be shown that the following approximate equation is fulfilled:

$$\frac{{γ}^{S} - {γ}^{{SL}_{1}}}{( {γ}^{S} - {γ}^{{SL}_{1}} ) - T \frac{\partial }{\partial T} ( {γ}^{S} - {γ}^{{SL}_{1}} )} \approx \frac{{γ}^{{L}_{1}}}{{γ}^{{L}_{1}} - T \frac{\partial }{\partial T} {γ}^{{L}_{1}}} \\ \frac{{γ}^{S} - {γ}^{{SL}_{2}}}{( {γ}^{S} - {γ}^{{SL}_{2}} ) - T \frac{\partial }{\partial T} ( {γ}^{S} - {γ}^{{SL}_{2}} )} \approx \frac{{γ}^{{L}_{1}}}{{γ}^{{L}_{2}} - T \frac{\partial }{\partial T} {γ}^{{L}_{2}}} \qquad ( 5 )$$

From (4) and (5):

$$W = \frac{{Δ}_{imm} {u}_{1} \frac{{γ}^{{L}_{1}}}{{γ}^{{L}_{1}} - T \frac{\partial {γ}^{{L}_{1}}}{\partial T}} - {Δ}_{imm} {u}_{2} \frac{{γ}^{{L}_{2}}}{{γ}^{{L}_{2}} - T \frac{\partial {γ}^{{L}_{2}}}{\partial T}}}{A {γ}^{{L}_{1} {L}_{2}}} \qquad ( 6 )$$

Thus, for determining the wettability parameter two experiments should be carried out to determine heat of immersion. The experiments should start from the same initial controlled state of the surface (for example, from vacuum). Heat of immersion by one liquid and then (after repeated pre-treatment of the sample) heat of immersion by another liquid should be measured. In DSC it is possible to carry out these two experiments simultaneously, studying the differential effect, i.e. by simultaneous wetting of two identical samples or two parts of the sample by one liquid in the cell with the sample, and by another liquid in the reference cell (the sample should be homogeneous enough and both parts of the sample should have approximately the same surface area). Measurements of the surface area A of the sample can be conducted using any known methods (for example, BET Adsorption of Gases in Multimolecular Layers. Brunauer, S., Emmett, P. and Teller, E. 1938, J. Am. Chem. Soc., Vol. 60, p. 309), or with the same experimental unit using a modified Harkins-Jura method (Partyka S., Rouquerol F., Rouquerol J. “Calorimetric determination of surface areas: possibilities of a modified Harkins and Jura procedures”. Journal of colloid and interface science, Vol. 68, No. 1, January 1979).

Measurements of interfacial tension between the liquids γ^{L}^{₁}^{L}^{₂} and measurements of surface tension of the liquids in equilibrium with their own saturated vapors γ^{L}^{₁}, γ^{L}^{₂}, as well as temperature-dependent variations of interfacial and surface tensions

$$\frac{\partial }{\partial T} {γ}^{{L}_{1}} , \frac{\partial }{\partial T} {γ}^{{L}_{2}}$$

at the required pressure can be conducted separately, for example, by the spinning and sitting drop method, etc.

Different types of calorimeter cells are used for measuring heat of immersion. The most commonly used is a sealed cell into which a sample sealed in an air-tight glass flask is placed. The glass flask with the sample is vacuumed and sealed, which allows to obtain a controlled surface condition of the sample before the experiment. The glass flask is broken during the experiment and the sample is wetted by a liquid. A membrane cell is a cell which is normally divided into two parts by a metal membrane. The lower part contains the sample, and the upper part is filled with a liquid. The membrane is ruptured during the test, and the liquid flows into the lower part of the cell. An advantage of the membrane cell is that in this case there is no need to seal the sample in the glass flask. A disadvantage of the membrane cell is that the sample in this case is not vacuumed, which may result in serious errors in heat of immersion measuring. Another type of cell combines advantages of the previous two types of cells. The sample and the liquid in such cell are separated by a membrane, and the lower part of the cell has a vacuum lock allowing the cell to be vacuumed before the experiment. A common disadvantage of all the above types of cells is that pressure cannot be controlled during the experiment because the cells have no communication with other parts of the calorimeters provided by tube connections. Besides, it is difficult or even impossible to carry out experiments under high pressure in these cells.

In the work by R. Denoyel, I. Beurroies, B. Lefevre, “Thermodynamics of wetting: information brought by microcalorimetry,” J. of Petr. Sci. and Eng., 45, 203-212, 2004, a device for determining heat of immersion was proposed wherein pressure inside a cell can be controlled. The cell is connected by tubes through a T-adapter with a vacuum pump used for vacuuming the sample before the experiment. The other end of the cell is connected to the system used for supplying a liquid into the cell and creating pressure of this liquid in the cell. It should be noted that the liquid supplied into the cell must have about the same temperature as the temperature in the cell to avoid creating another heat flux which may introduce errors in heat of immersion measurements. Such or similar system should be used for measuring heat of immersion according to the proposed method because in this case a sample can be prepared (vacuumed) before wetting and the final pressure in the system can be controlled.

Additional heat effects taking place during the experiment should be considered in each of the proposed equipment configurations, such as: heat effects related to glass flask breaking or membrane rupture, as well as to evaporation of part of the liquid; heat effect caused by temperature differences between the liquid supplied to the cell and the cell temperature; heat effect related to liquid compression inside the cell (when the cell is pressurized to a required pressure) (FIG. 5), etc. Normally, these heat effects can be considered by additional measurements.

The method for wettability determination in accordance with this disclosure can be implemented as follows.

A surface of a sample is cleaned. For example, rock core samples used in petroleum industry are normally subject to extraction, then vacuumed at high temperature in vacuum oven. Core sample drying temperature and time are selected depending on properties of a given core sample. For example, rock samples are vacuum-dried at a high (˜100° C.) temperature for rather a long time (about 24 hours) to remove moisture. Fast drying is possible at higher temperatures, if high temperatures will not cause any structural changes in the rock sample surface.

The sample is placed into a sealed cell of calorimeter and vacuumed. In this case, sample cleaning and vacuuming can be combined, if calorimeter cell design allows vacuum drying of the sample at high temperatures directly in the calorimeter cell. Vacuuming of the sample is not necessary if it will not have any effects on the final result of the experiment, i.e. heat of immersion.

The cell with the sample is held at a temperature at which wettability of the sample should be measured until stabilization of the heat flow.

Wetting liquids used for determining heat of immersion are also pre-treated. Since in this experiment equilibrium wetting is studied, the liquids used during the experiment should also be brought in the state of equilibrium, which is achieved by putting the liquids into contact with each other at temperature and pressure same as the temperature and pressure at which heat of immersion is measured.

Then the experiment is conducted to determine heat of immersion of the sample by a first wetting liquid. In order to measure the heat of immersion, the calorimeter is calibrated and electric signal from calorimeter sensors is measured to estimate a heat flow; summation of the heat flow, with deduction of baseline values, allows for determining wetting energy.

The sample is cleaned, vacuumed and brought into a condition as similar as possible to the condition that existed before the sample was wetted by the first liquid. Then the experiment is conducted to determine heat of immersion of the sample by a second wetting liquid.

If two identical samples are used, or if the sample is homogeneous enough and can be split into two parts with similar properties, then simultaneous measurements of heats of immersion by two wetting liquids can be taken. For this purpose, the samples are placed in different cells and wetted simultaneously by two different wetting liquids.

Additional heat effects, not related to sample wetting, should be considered.

The formula (6) is used to find parameter of the wetting of the surface of the sample by these two fluids. Interfacial tension between the liquids, surface tensions of two liquids and variation of the surface tensions of the liquids with temperature at a given pressure are considered as known parameters. Such known parameters can be determined from table values for the known liquids, or they can be determined by measurements, for example, using sessile or spinning drop methods at a given pressure and temperature. The surface area of the sample required for calculating the wettability parameter could be found from a separate experiment, for example, using gas adsorption method or using a calorimeter according to the Harkins-Jura method or any other known method. The Harkins-Jura method works well only with surfaces wetted by this liquid. For example, water (in the solid-water-water vapor system) can be used with hydrophilic surfaces, or hydrocarbons with hydrophobic surfaces.

1. A method for determining wettability of a surface, comprising:
placing at least one sample of a material into at least one sealed cell of a calorimeter,
providing a contact of the at least one sample with a first wetting liquid and with a second wetting liquid at the same pressure and temperature,
measuring heats of immersion of the at least one sample by the first and the second wetting liquids, and
calculating wettability as:
$$W = \frac{{Δ}_{imm} {u}_{1} \frac{{γ}^{{L}_{1}}}{{γ}^{{L}_{1}} - T \frac{\partial {γ}^{{L}_{1}}}{\partial T}} - {Δ}_{imm} {u}_{2} \frac{{γ}^{{L}_{2}}}{{γ}^{{L}_{2}} - T \frac{\partial {γ}^{{L}_{2}}}{\partial T}}}{A {γ}^{{L}_{1} {L}_{2}}}$$
where:
Δᵢₘₘu₁ is a heat of immersion of the surface of the sample by the first wetting liquid, J,
Δᵢₘₘ₂ is the heat of immersion of the surface of the sample by the second wetting liquid, J,
A—is a surface area of the sample,
γ^{L}^{₁}—a surface tension of the first wetting liquid in equilibrium with its vapor, N/m,
γ^{L}^{₂}—a surface tension of the second wetting liquid in equilibrium with its vapor, N/m,
γ^{L}^{₁}^{L}^{₂}—an interfacial tension between the first and the second wetting liquids, N/m,
T—temperature at which measurements are carried out, K,
$$\frac{\partial }{\partial T} {γ}^{{L}_{1}}$$
—a change in the surface tension of the first wetting liquid with temperature, N/(m·K),
$$\frac{\partial }{\partial T} {γ}^{{L}_{2}}$$
—a change in the surface tension of the second wetting liquid with temperature, N/(m·K).

2. The method of claim 1 wherein the first and the second wetting liquids are brought into contact with each other at the pressure and temperature at which the heats of immersion are determined.

3. The method of claim 1 wherein the surface area of the sample required for calculating the wettability is determined using a gas adsorption method.

4. The method of claim 1 wherein the surface area of the sample required for calculating the wettability is determined using a calorimeter by the Harkins-Jura method.

5. The method of claim 1 wherein the interfacial tension between the first and the second wetting liquids, the surface tensions of the wetting liquids in equilibrium with their own vapors and the changes in the surface tensions of the liquids are determined using the spinning drop method or the sessile drop method.

6. The method of claim 1 wherein the sample is brought into contact with the first wetting liquid and the sample surface heat of immersion by the first wetting liquid is measured, then the sample surface is cleaned and the sample is brought into contact with the second wetting liquid in the same calorimeter cell and the sample surface heat of immersion by the second wetting liquid is measured.

7. The method of claim 1 wherein the sample is vacuumed before contacting with the wetting liquids.

8. The method of claim 1 wherein the sample is dried and cleaned before contacting with the wetting liquids.

9. The method of claim 1 wherein the cell with sample is held at the temperature at which the heat of immersion of the sample surface is measured until stabilization of the heat flow.

10. The method of claim 1 wherein two identical samples with the same surface area are used, each of the samples is placed in a separate cell, one of the samples is brought into contact with the first wetting liquid, the second sample is brought into contact with the second wetting liquid, and heat of immersion of the surface of the first sample by the first wetting liquid and heat of immersion of the surface of the second sample by the second wetting liquid are measured simultaneously.

11. The method of claim 10 wherein the samples are vacuumed before contacting with the wetting liquids.

12. The method of claim 10 wherein the samples are dried and cleaned before contacting with the wetting liquids.

13. The method of claim 10 wherein the cells with the samples held at the temperature at which the heat of immersions of the surfaces of the samples are measured until stabilization of the heat flow.

14. The method of claim 1 wherein a rock core is used as the sample.

15. The method of claim 14 wherein oil and brine are used as the first and the second wetting liquids.

16. The method of claim 15 wherein oil and brine at in-situ pressure and temperature are used as the first and the second wetting liquids.
